(19) United States
(12) Patent Application Publication
(10) Pub. No.: US 2008/0030990 A1
(43) Pub. Date: Feb. 7, 2008

(54) Lighting System Comprising a Mask with Small Apertures

(75) Inventor: Michael John Hanney, Berkshire (GB)

Correspondence Address: OCCHIUTI ROHLICEK & TSAO, LLP, 10 FAWCETT STREET, CAMBRIDGE, MA, 02138, US

(73) Assignee: SET EUROPE LIMITED, Lancashire (GB)

(21) Appl. No.: 11/574,826

(22) PCT Filed: Sep. 7, 2005
(86) PCT No.: PCT/GB05/50146

§ 371 Date: Sep. 21, 2007

(30) Foreign Application Priority Data
Sep. 7, 2004 (GB) 0419859.4

(51) Int. Cl. F21V 13/04; B29D 11/00; F21V 5/02

(52) U.S. Cl. 362/240; 264/2.7; 362/309; 362/311; 362/339

(57) ABSTRACT

A lighting unit comprises an optical component (1) having an interior surface (3) and an exterior surface (5), the interior surface (3) of the optical component (1) for receiving a beam (10) of collimated light incident thereon, and the exterior surface (5) forming an exterior surface of the lighting unit. The optical component (1) comprises a plurality of Fresnel or diffractive lens elements (9) arranged to focus the beam of light (10) to a corresponding plurality of points in a predefined pattern on the exterior surface (10) thereof. The exterior surface (5) of the optical component (1) is provided with a substantially opaque mask (7) which is patterned with apertures at a plurality of points corresponding to the predefined pattern so that the light may emanate therethrough.

The present invention relates to lighting systems and, in particular, a novel lighting unit that may be used in exterior and interior lighting applications and incorporated in product designs.

The appearance of lighting systems incorporated in modern interior design, architecture and product design has become increasingly important. Thus, for example, concealed lighting has been developed, for use in lighting applications such as kitchens, in which an incandescent light bulb is concealed so that it is not directly visible. However, the light beam emitted from concealed lighting, being from a conventional incandescent light bulb, cannot be controlled or shaped.

The present inventor set out to provide a lighting system or unit that may be integrated in modem interior and exterior lighting designs and product designs, which enables the light beam to be optically controlled so that the emanating light beam may be shaped and directed in a desired manner.

In accordance with a first aspect, the present invention provides a lighting unit comprising an optical component having an interior surface and an exterior surface, the interior surface of the optical component optically connected to receive a beam of preferably collimated light incident thereon, and the exterior surface forming an exterior surface of the lighting unit, the optical component comprising a plurality of Fresnel or diffractive lens elements arranged to focus the beam of light to a corresponding plurality of points in a predefined pattern on or near the exterior surface thereof, wherein the exterior surface of the optical component is provided with a substantially opaque mask which is patterned with apertures at a plurality of points corresponding to the predefined pattern so that light may emanate therethrough.

The lighting unit of the present invention thus has a substantially opaque external appearance, the colour, texture and other characteristics of the external finish of which may be coordinated with the surface of the product or surroundings into which it is to be incorporated.

For instance, in order to provide a desired appearance, the substantially opaque mask may be coloured or patterned so that the finish of the external surface of the optical component/lighting unit blends with its surroundings when no light is incident on the interior surface of the component. In this way, the visible exterior of the lighting unit blends into the surrounding product or design and is effectively hidden when it is unlit, but emits a controlled, highly efficient light beam when illuminated, resulting in visually appealing and also technically useful effects.

The lighting unit may be used in interior or exterior lighting applications, for instance, it may be incorporated to coordinate with wall and ceiling panels, so that, for example, wall tiles might apparently light up to illuminate a kitchen. The lighting unit may be used in product design applications, for example in vehicle lighting, whereby the lighting unit may be coordinated with contoured exterior body panels or interior trim into which it can be incorporated.

The optical component may be tinted so that the light emitted from each aperture of the lighting unit is coloured.

In one embodiment, each lens element is a Fresnel lens. In this embodiment, the optical component operates most efficiently when collimated light is incident on the interior surface. Preferably, each lens is adapted to focus substantially normally incident light through a corresponding aperture in the mask.

In a preferred embodiment, the lighting unit further comprises a light source, wherein the interior surface of the optical component is disposed towards the light source. In one embodiment, the light source is incandescent and has a reflector on the opposite side to the optical component. Preferably, the reflector is parabolic such that the reflected light is collimated.

In an alternative embodiment, the light source comprises a Light Emitting Diode (LED), and preferably, the light source is an array of LEDs. Preferably, the or each LED has an associated collimating optic to provide collimated light. Preferably, the or each LED provides light at a single wavelength or across a narrow band of wavelengths, but having a single dominant wavelength to provide a predominant colour of light.

In an alternative embodiment, each lens element of the optical component is adapted, according to its position relative to a light source, such that each lens element focuses light directly from or reflected from the light source through a corresponding aperture in the mask. Such an embodiment provides the collimation and focusing of the light source in one optical component moulding.

In accordance with a second aspect, the present invention provides an optical component for use in a lighting unit according to the first aspect of the present invention.

In accordance with a third aspect, the present invention provides a product incorporating a lighting unit in accordance with the first aspect of the present invention.

In accordance with another aspect, the present invention provides a method for forming an optical component in accordance with the second aspect of the present invention, the method comprising: providing a mould for a plurality of Fresnel or diffractive lenses arranged in an array; moulding said optical component of a plastics material, and forming a substantially opaque mask on a first, exterior surface of the plastics moulded component, wherein the opaque mask is provided with apertures at a plurality of points corresponding to the predefined pattern

Further features and advantages of the present invention will be apparent from the following description and accompanying claims.

The above and other aspects of the present invention will now be described, by way of example, with reference to the accompanying drawings, in which:

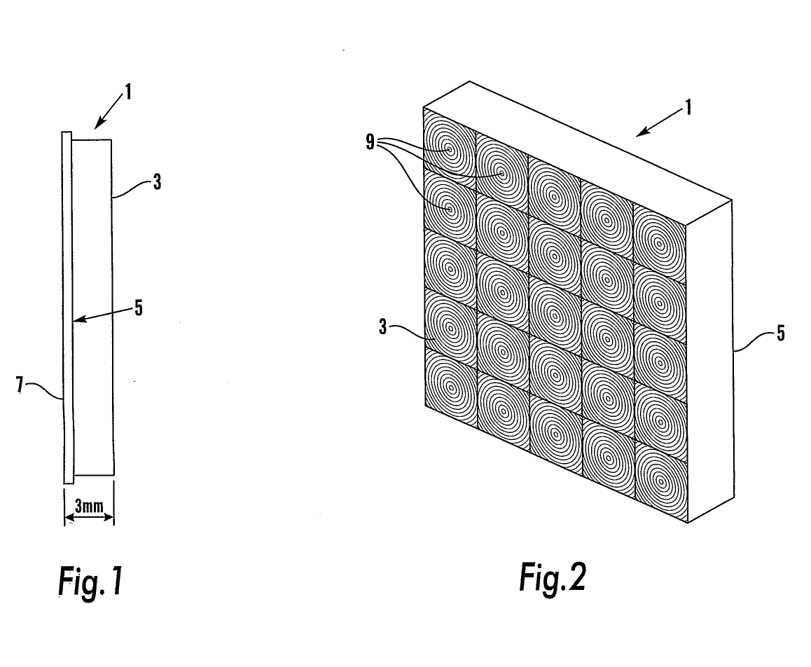

FIG. 1 is a side view of an optical component forming an embodiment of the present invention;

FIG. 2 is a perspective view of an optical component forming a preferred embodiment of the present invention comprising an array of Fresnel lens elements;

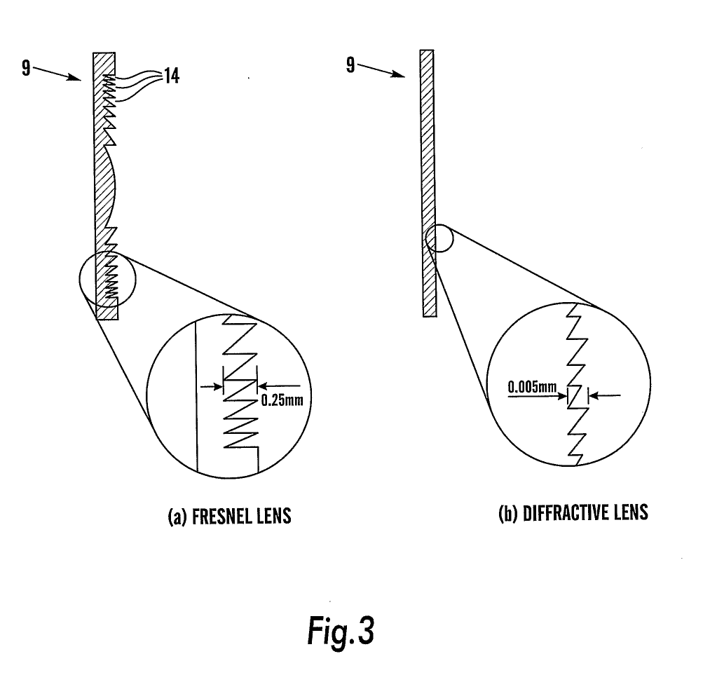

FIG. 3(a) is a cross section of a Fresnel lens element of the optical component of FIG. 2 and FIG. 3(b) is a cross section of a diffractive lens element of an alternative embodiment;

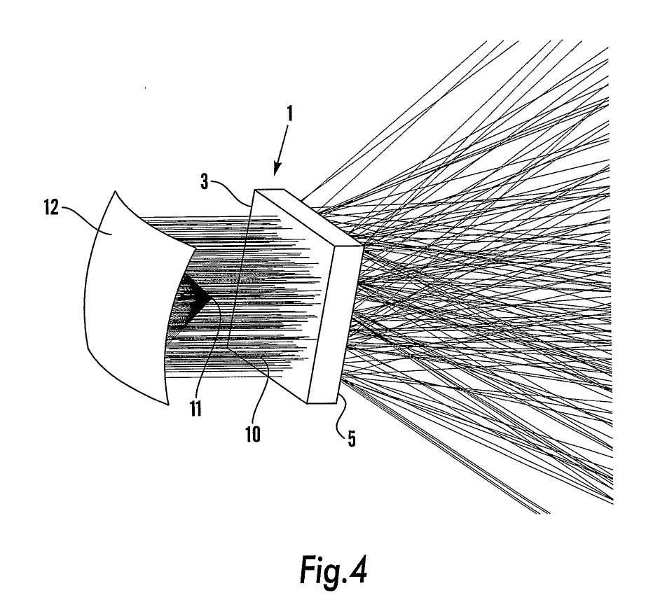

FIG. 4 is a ray trace of a lighting unit forming another embodiment of the present invention, the lighting unit comprising the optical component of FIG. 2;

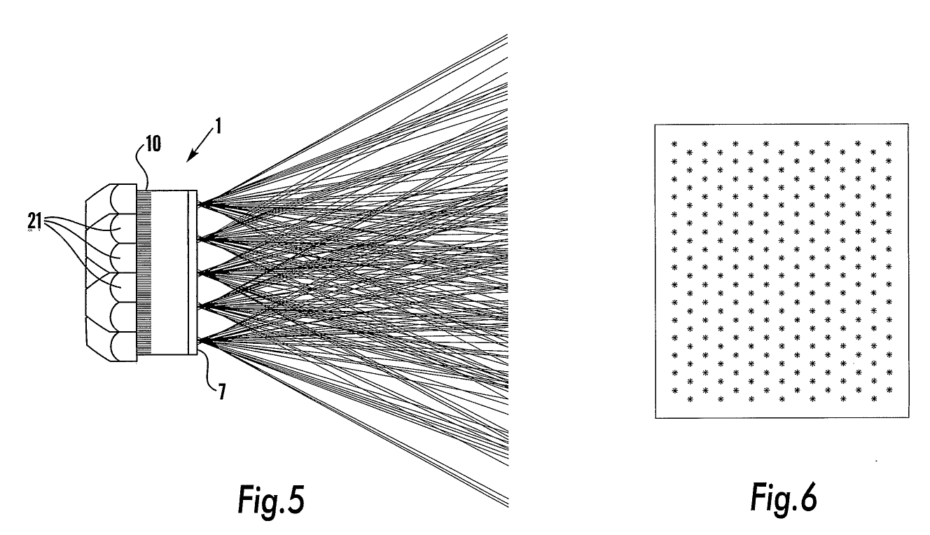

FIG. 5 is a ray trace of a lighting unit forming yet another embodiment of the present invention, the lighting unit comprising an array of LEDs with associated collimator optics and the optical component of FIG. 2; and

FIG. 6 is a schematic, plan view of the exterior surface of the optical component of the lighting unit of FIG. 5 showing the pattern of micro-perforations thereon.

FIG. 1 is a side view of an optical component 1 of a transparent plastics material and having a plurality of lens elements 9 integrally formed therein. The optical component 1 has an interior surface 3 and an exterior surface 5, the exterior surface 5 of which forms an exterior surface of a lighting unit into which it is incorporated, in use. An opaque mask 7 is provided on the exterior surface 5 of the optical component 1 and is provided with a plurality of micro-perforations arranged in a predefined pattern corresponding to the plurality of lens elements, as described below. In a preferred embodiment, the optical component I is approximately 3 mm thick. The optical component I may be formed from any appropriate optical plastics material, such as polycarbonate, or, alternatively from glass for use with powerful incandescent light sources. It may be tinted so that the light emitted by a lighting unit incorporating the optical component is coloured.

In a preferred embodiment, as shown in FIG. 2, the lens elements are refractive Fresnel lens elements 9. Conventional refractive lens elements are not suitable for the applications envisaged by the present invention due to the bulky nature of such lenses. In other embodiments, diffractive lens elements may be used as an alternative to refractive Fresnel lens elements 9. Although the illustrated Fresnel lens elements 9 are of essentially identical form, it will be appreciated that the lens elements 9 may have different forms in order to shape and control the light beam in the desired pattern and direction.

The lens elements 9 are shown in a grid pattern or array but greater efficiency may be achieved by moving every second row of lens elements down by half a diameter, thereby packing as many circular lens elements as possible into a given area of the array.

Each Fresnel lens element 9 comprises a plurality of concentric rings 14 formed on the interior surface 3 of the optical component 1. Each ring 14 has a different diameter and has a substantially saw-tooth cross section, as is known in conventional Fresnel lens design. A cross section along a diameter of single Fresnel lens element 9 is shown in FIG. 3(a). In this refractive Fresnel lens, the features extend approximately 0.25 mm from the lens surface. In an alternative embodiment comprising diffractive lens, the features may extend between approximately 0.02 and 0.005 mm from the lens surface forming the interior surface 3 of the optical component 1, as shown in FIG. 3(b).

It will be appreciated that the characteristics of each lens element 9 may be adjusted by varying the number, size and cross section of the rings 14 or by positioning the rings 14 such that they are not concentric. This enables each lens element 9 to focus light from a particular direction on a particular point. It is not essential that all the lens elements 9 are identical and each lens element 9 may be adapted according to its position in the array of the optical component 1. This allows for adjustment according to the direction in which light is incident on the lens element 9 and in order to control the direction in which light passing through the lens element 9 travels. It also allows for adjustment of the optical properties of an array of lens elements with a non-planar optical component 1.

The optical component 1 may be manufactured using conventional moulding techniques. Such techniques are sufficiently accurate to define the small features of each lens element 9. However, lithographic techniques may also be used. If the optical component is to be made of glass, a moulding and embossing process may be employed. It is also possible for the lens elements 9 to be imprinted or etched onto a plastic film applied to an array substrate using known In-Mould Labelling (IML) techniques.

In-Mould Labelling is carried out as follows. A thin film of plastic with the desired optical or decorative properties is cut to an appropriate shape to form a label. The label is placed in a moulding tool, preferably against one side of the mould cavity. Plastic for forming the component is injected into the cavity. When the plastic sets, the label is permanently attached to the moulded component and a fully decorated product is produced directly from the moulding process. This process is used, for example, to manufacture facia components for mobile telephones.

The substantially opaque mask 7 may comprise any suitable opaque material such as ink, paint or coloured film. It may be applied to the exterior surface 5 of the optical component 1 using conventional printing techniques or it may be printed onto a film and applied to the optical component 1 using known IML techniques. A predefined pattern of micro-perforations or apertures in the mask 7, for example, as illustrated in FIG. 6 and described below, may be applied to the mask 7 as part of the imprinted graphic or pattern. Alternatively the mask may be applied as a uniform coating and the apertures formed in a predefined pattern therein subsequently, for example using laser ablation. The mask 7 may be plain or decorated, with a finish to match the intended setting of the optical component 1.

The predefined pattern of micro-perforations in the mask 7 is such that each perforation or aperture is aligned with one of the lens elements 9 in the optical component 1. Sufficient alignment can be achieved using conventional jigging techniques. The size and shape of each perforation is adapted to provide the desired visual appearance.

The optical component 1 described above can be used in a lighting unit in conjunction with incandescent light sources or Light Emitting Diodes (LEDs).

FIG. 4 shows an internal arrangement of a lighting unit of an embodiment of the present invention comprising an incandescent light source 11 positioned between a parabolic mirror 12 and the above-described optical component 1. The optical component 1 is positioned such that the opaque mask 7 faces away from the light source 11 and forms an external surface of the lighting unit. Light emitted by the light source 11 is reflected and collimated by the parabolic mirror 12 and the resulting light beam 10 is incident substantially normally on the interior surface 3, and thus the lens elements 9, of the optical component 1.

Each lens element 9 in the array of the optical component 1 is adapted to focus the incident light 10 through a corresponding micro-perforation in the opaque mask 7 so that the light is emitted from the lighting unit. In particular, each lens element 9 focuses incident light to a point corresponding to the position of the micro-perforation in the mask 7. Since the light diverges from the focus point through each micro-perforation, the effect is that the light appears to emanate from the entire opaque surface, rather than simply small points of light from the micro-perforations.

In another embodiment, as shown in FIG. 5, the internal arrangement of a lighting unit comprises a plurality of LEDs in place of the incandescent light source 11 of the embodiment of FIG. 4. The single wavelength light beam 10 emitted by the or each LED is collimated using a conventional LED collimator optic 21, such as that available from Polymer Optics Limited, Wokingham, UK. As shown in FIG. 5, the LEDs with associated collimator optics 21 may be tessellated in a honeycomb arrangement to provide a source of substantially collimated light. Such a light source can be positioned behind an optical component 1 in place of the light source and mirror of the embodiment of FIG. 4, to provide a neat and compact lighting system with the aesthetic and technical advantages described above.

FIG. 6 illustrates, by way of example, a pattern of micro-perforations formed in the mask 7 on the exterior surface of the optical component 1 of the lighting unit of FIG. 5. Each micro-perforation is associated with a Fresnel lens element 9. In particular, each micro-perforation or aperture is positioned so that light is focussed by a lens element 9 to a point substantially coincident with the corresponding aperture, as illustrated in FIG. 5. Whilst the outline of the illustrated pattern of apertures is generally rectangular, the pattern may take any suitable form for the desired application.

The lighting unit of the present invention has widespread application for lighting systems, since it is effectively hidden when not illuminated, but provides a controlled and directed beam of light of any desired shape when illuminated.

One such application of the present invention is external lighting on automobiles. The opaque mask surface may be finished to match the body panel of a vehicle, for example, it may be painted using conventional techniques for car body panels. In this way, when the automobile lamp is off, the vehicle appears to have no lights. When the lighting unit is turned on, the light appears to emanate through the solid body of the vehicle in a controlled and directed beam.

Such a technique also provides anti-phantom benefits to automotive applications, since external light is not reflected by the opaque mask surface, and provides a high contrast between the on and off states of the light, even in high levels of direct sunlight.

The optical component 1 of the lighting unit may be tinted to provide the necessary colours (red for breaking lights, orange for indicator lights etc.), however, it is more energy efficient if the light source comprises one or more appropriately coloured LEDs. In this case, the emitted light already has the correct wavelength and the optical component does not need to absorb and dissipate the energy from light of other wavelengths. This energy would otherwise be dissipated as heat and leading to overheating of the lighting unit and possibly melting of the optical component.

As the skilled person will appreciate, various modifications and changes may be made to the described embodiments. The present invention encompasses all such variations, modifications and equivalents which fall within the scope of the present invention as defined in the accompanying claims.

1. A lighting unit comprising an optical component having an interior surface and an exterior surface, the interior surface of the optical component for receiving a beam of light incident thereon, and the exterior surface forming an exterior surface of the lighting unit, the optical component comprising a plurality of Fresnel or diffractive lens elements arranged to focus the beam of light to a corresponding plurality of points in a predefined pattern, wherein the exterior surface of the optical component is provided with a substantially opaque mask which is patterned with apertures at a plurality of points corresponding to the predefined pattern so that the light may emanate therethrough.

2. A lighting unit as claimed in claim 1, in which each lens element of the optical component is adapted to focus and/or direct light incident thereon in a predetermined direction through a corresponding aperture.

3. A lighting unit as claimed 1, further comprising a light source, wherein the interior surface of the optical component is disposed towards the light source.

4. A lighting unit as claimed in claim 3, in which the light source comprises an incandescent light source, and a parabolic reflector on the opposite side to the optical component so that reflected from the parabolic reflector is collimated.

5. A lighting unit as claimed in claim 3, in which the light source comprises a Light Emitting Diode (LED).

6. A lighting unit as claimed in claim 5, in which the light source comprises a plurality of LEDs arranged in an array, each LED directing light upon one or more of said lens elements.

7. A lighting unit as claimed in claim 5, in which the, or each, LED has an associated collimator optic to provide collimated light.

8. A lighting unit as claimed in claim 3, in which each lens element of the optical component is adapted, according to its position relative to a light source, such that each lens focuses light directly from or reflected from the light source in a predetermined direction through a corresponding aperture in the mask.

9. A product incorporating a lighting unit as claimed in claim 1, in which the substantially opaque mask is adapted to blend in with, or contrast with, the surface of the surrounding product when the lighting unit is not illuminated.

10. A product as claimed in claim 9, in which the substantially opaque mask has a finish similar to the finish of the surface of the surrounding product, so that the lighting unit is substantially concealed when the lighting unit is not illuminated.

11. An optical component for a lighting unit as claimed in claim 1.

12. An optical component as claimed in claim 11, in which the optical component is formed from a plastics material.

13. An optical component as claimed in claim 11, in which the optical component is tinted so that when light is incident thereon, the light emitted from each aperture in the opaque mask is coloured.

14. A method for forming an optical component as claimed in claim 11, comprising: providing a mould for a plurality of Fresnel or diffractive lenses arranged in an array; moulding said optical component of a plastics material; forming a substantially opaque mask on a first, exterior surface of the plastics moulded component, wherein the opaque mask is provided with apertures at a plurality of points corresponding to the predefined pattern.

15. A method as claimed in claim 14, in which the step of forming a substantially opaque mask is performed using one of: in mould labelling; ink transfer decoration; pad printing; screen printing; applying a hard coating, and spray painting.

16. A method as claimed in claim 14, in which the opaque mask is formed by applying a substantially uniform, opaque mask to the exterior surface of the plastics moulded component, and thereafter removing the mask to defined said apertures at a plurality of points corresponding to the predefined pattern.

17. A method as claimed in claim 16, in which the step of removing is performed by etching or laser ablation.

18. A lighting unit as claimed in claim 2, further comprising a light source, wherein the interior surface of the optical component is disposed towards the light source.

19. A lighting unit as claimed in claim 18, in which the light source comprises an incandescent light source, and a parabolic reflector on the opposite side to the optical component so that light reflected from the parabolic reflector is collimated.

20. A lighting unit as claimed in claim 18, in which the light source comprises a Light Emitting Diode (LED).
